(19) United States
(12) Patent Application Publication
(10) Pub. No.: US 2014/0109462 A1
(43) Pub. Date: Apr. 24, 2014

(54) Fishing Weight

(71) Applicant: Dave Harding, Portland, OR (US)

(72) Inventor: Dave Harding, Portland, OR (US)

(21) Appl. No.: 13/939,565

(22) Filed: Jul. 11, 2013

Related U.S. Application Data
(60) Provisional application No. 61/717,158, filed on Oct. 23, 2012.

(51) Int. Cl. A01K 95/00

(52) U.S. Cl. CPC A01K 95/005; A01K 95/00
USPC 43/43.1; 156/85

(57) ABSTRACT

In one embodiment, the present invention contemplates an improved fishing weight. The weight includes a soft carbon steel ball adhered to a half-eye swivel mount having an eyelet. A shrink-wrap film encases a substantial portion of the ball and the base of the swivel mount, leaving the eyelet exposed and able to rotate about 360-degrees around an axis.

### PRIORITY CLAIM

The present application claims benefit under 35 USC Section 119(e) of U.S. Provisional Patent Application Ser. No. 61/717,158 filed on 2012 Oct. 23 titled “Improved Fishing Weight” by a common inventor: The present application is based on and claims priority from this application, the disclosure of which is hereby expressly incorporated herein by reference.

### BACKGROUND

The present invention relates to devices used to as fishing weights, and more specifically to lead-free fishing weights.

In the past, lead was the primary component of fishing sinkers, jigs, and weights. Lead is malleable, easy to form into desired shapes, and relatively easy to come by with low direct cost. However, lead is a toxic metal that has adverse effects on the nervous and reproductive systems of mammals and birds. And, due to is prolific use in most fishing jigs and sinkers, the affects of lead poisoning in wildlife, such as loons and eagles, was more-recently noted by environmentalists, sportsman, and various governmental agencies.

Lead, whether from direct ingestion or by ingesting an animal that ingested a lead weight, for example, when lead fishing sinkers are lost through broken line or other means, contaminates the bird or fish, or other creature. For example, water birds like loons and swans often swallow lead when they scoop up pebbles from the bottom of a lake or river to help grind their food. Eagles ingest lead by eating fish, which have themselves swallowed sinkers.

The dangers of lead poisoning include both physical and behavioral changes, including loss of balance, gasping, tremors, and impaired motor abilities (i.e. the ability to fly in birds). And, a weakened bird is more vulnerable to predators, or it may have trouble feeding, mating, nesting, and caring for its young. It becomes emaciated and often dies within two to three weeks after eating the lead.

Evidence of problems attributed to lead fishing weights includes a research study on loons from six New England states. This study demonstrated that the majority of lakes where dead adult breeding loons were found between 1987 and 2002, about 26% of these loons died from lead poisoning. In Michigan, another 15-year study examined 186 dead loons and revealed that lead poisoning—primarily from lead jigs—was the number one cause of death at 24% of overall mortality. Limited research in Minnesota has also documented lead poisoning of loons. A study conducted by the Minnesota Pollution Control Agency concluded that lead poisoning accounted for 12% of the dead adult loons with known causes of death.

Between 1980 and 1996, the Raptor Center at the University of Minnesota reported lead poisoning in 138 of 650 eagles they treated. Since 1996, 43 additional eagles were treated for lead poisoning including 22 last year.

Because of the known dangers associated with lead weights, many states adopted a ban on this material. For example, effective May 1, 2011, the State of Washington prohibits the use of lead weights and jigs on 12 lakes in the state where loons breed and raise their young. New Hampshire has banned the use and sale of lead fishing sinkers that weigh less than an ounce and lead jigs smaller than an inch. Maine and New York have banned the sale of lead sinkers weighing a half-ounce or less. And, in 2004, the Vermont Legislature passed a bill banning the sale and use of lead sinkers weighing ½ ounce or less throughout the sate. The U.S. Fish and Wildlife Service banned lead sinkers in two national wildlife refuges and Yellowstone National Park.

Because of this trend to eliminate dangerous lead weights, there is a need for a cost-effective, lead-free fishing weight. Some attempts at providing lead-free tackle include a tumbled limestone body including a break-away swivel fastener as described by Pauley et al. in U.S. Patent Application Publication No. US2011/0041380 published on 2011 Feb. 24. However, limitations of this device include a cost-ineffective process of collecting, sorting, selecting, and tumbling limestone. Then boring a hole in the limestone is difficult and finally securing a fastener to the limestone in a manner to prevent subsequent inadvertent dislodging is difficult to achieve. Thus, there remains a need for a more cost-effective and efficient process of making a lead-free fishing weight that also better secures the swivel fastener.

Other non-lead devices disclosed include a frangible material, such as bismuth having a skin or adhesive outer layer, in U.S. Pat. App. Pub. Nos. US2005/0055868 on 2005 Mar. 17 and US2004/0000385 on 2004 Jan. 1 both to Ratte; a row of non-toxic biodegradable metal balls (soft carbon steel shot) surrounded and encased by a non-toxic, biodegradable woven sleeve in U.S. Pat. No. 5,243,779 to Reed on 1993 Sep. 14; and a wolframite material in U.S. Pat. No. 3,852,907 issued on 1974 Dec. 10 to Haught.

Other attempts include surrounding a lead material or a partial lead material with a casing. These examples include a jacket material as described by Haught in U.S. Pat. No. 3,852,907 issued on 1974 Dec. 10; a tubular jacket of Polyolefin (steel balls) described by Biss in U.S. Pat. No. 5,233,786 issued on 1993 Aug. 10; and a zinc or zinc alloy coating over lead described by Tom et al. in U.S. Pat. No. 6,938,552 issued on 2005 Jul. 6.

Despite these attempts, there remains yet a need for a simple, effective, cost-economical, easy to produce, inexpensive to purchase, elegant solution to provide a fishing weight that eliminates toxic metals such as lead and other harmful components. Yet another need is a tangle-free fishing lure that does not snag or become lodged on rocks and other debris commonly found on the bottom of lakes and streams. Some attempts to provide tangle free fishing weights include a fish line sinker described by Hoerner in U.S. Pat. No. 3,151,414 issued on 1964 Oct. 6 or the linkable sinker described by Brasseur in U.S. Pat. No. 7,621,071 issued on 2009 Nov. 24.

Thus, there remains a need for a tangle-free fishing weight or lure or sinker that does not use lead, but overcomes the limitations discussed above.

### DRAWING

FIG. 1 illustrates a component assembly front view of one preferred embodiment according to the present invention.

FIG. 2 is a front view of the assembled fishing weight of FIG. 1.

FIG. 3 illustrates the rotating swivel eyelet feature of the present invention.

FIG. 4 is another view of the rotating eyelet of FIG. 3.

FIG. 5 is a front view of a second preferred embodiment of the present invention.

### DESCRIPTION OF THE INVENTION

Possible embodiments will now be described with reference to the drawings and those skilled in the art will understand that alternative configurations and combinations of components may be substituted without subtracting from the invention. Also, in some figures certain components are omitted to more clearly illustrate the invention.

In the prior art, lead weights, apart from the environmental concerns, worked well as fishing weights. They were easy to make and inexpensive to buy, the density of lead enabled a small amount of material to suitably weight fishing line. But, in part due to their inexpensive nature, lead weights often fell off the fishing line or were ripped of the line when snagged, falling to the bottom of lakes and streams and ingested by fish and fowl. Little effort was made by the fishing weight industry to improve upon this design, despite the loss of product to the fisherman—as product lost on the bottom of the lake meant another sale to the fisherman of these inexpensive weights.

Today, however, the loss of lead weights is measured in ecological cost and, accordingly, many communities have banned the sale and/or use. The present invention provides a solution by improving the design to fishing weights to ensure that the weights are less likely to be lost in the first place, and second, eliminates the deadly lead from the product.

Accordingly, in a preferred embodiment of the present invention, a fishing weight 10 comprises a stainless steel ball 20 coupled by an adhesive to a half swivel mount 30, and this assembly is covered by a sheet of shrink wrap tubing 40.

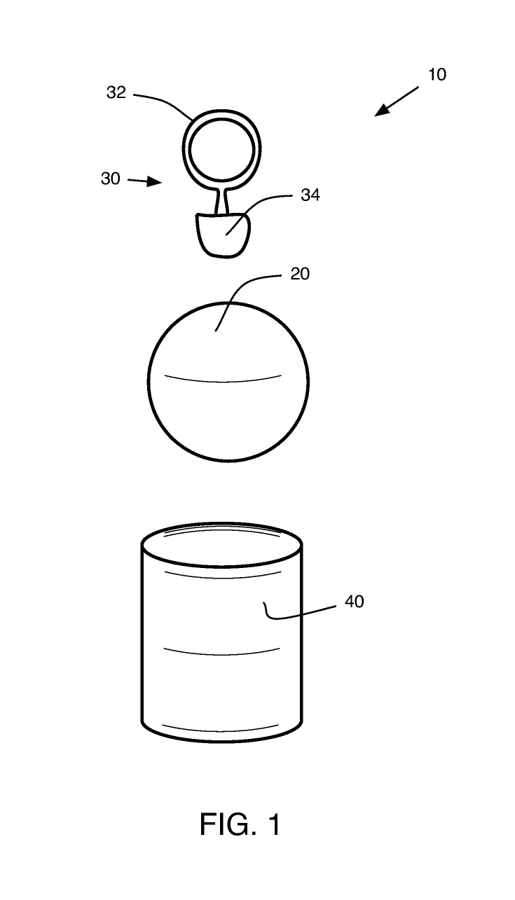

FIG. 1 illustrates the components of this preferred embodiment. The components include a half-eye swivel 30 having a base 34 and eyelet 32. An adhesive, not shown in this view, affixes the base 34 to the ball 20. The ball 20 is a soft carbon steel ball. And an outer sheath material, such as a polyolefin heat shrink-wrap film 40 encases the ball 20 and portion of the swivel 30.

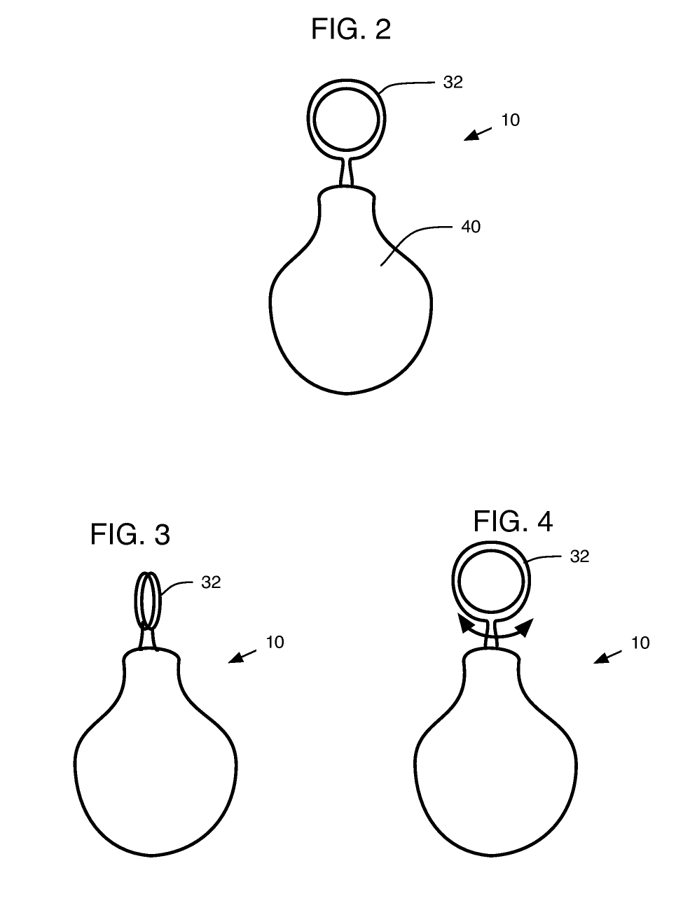

FIG. 2 more clearly illustrates the assembled embodiment depicted in FIG. 1. A portion of the swivel 30, specifically the eyelet 32 extends outside the outer sheath 40. And, FIGS. 3 and 4 illustrate the eyelet 32 of the swivel 30 and how it can rotate about a 360-degree axis relative to the ball 20.

One possible swivel 30 is available from Rosco Terminal Tackle a Rome Speciality Company, Inc. available from www.roscoinc.com of Rome, N.Y., USA. This particular swivel is a one-eyed, brass, swivel and they come in various sizes. Contemplated sizes include four specific sizes including size 1, 2/0, 4/0 and 6/0. Other materials and configurations of the swivel are contemplated. Some suitable materials for the swivel include stainless steel, brass, nickel plated brass, and black (brass) swivels.

One suitable shrink-wrap outer layer 40 is a polyolefin with a 3:1 shrink ratio and contemplated sizes include ½″, ¾″, 1″ and 1¼″ diameters of the heat shrink tubing and is available from www.uline.com, for example. Lengths of the heat shrink tubing vary upon ball size, as would be appreciated in the art. The adhesive that couples the ball to the swivel includes ethylenevinylacetate (EVA) hot melt adhesive wrap. And the balls, in various diameters, are balls are low carbon steel.

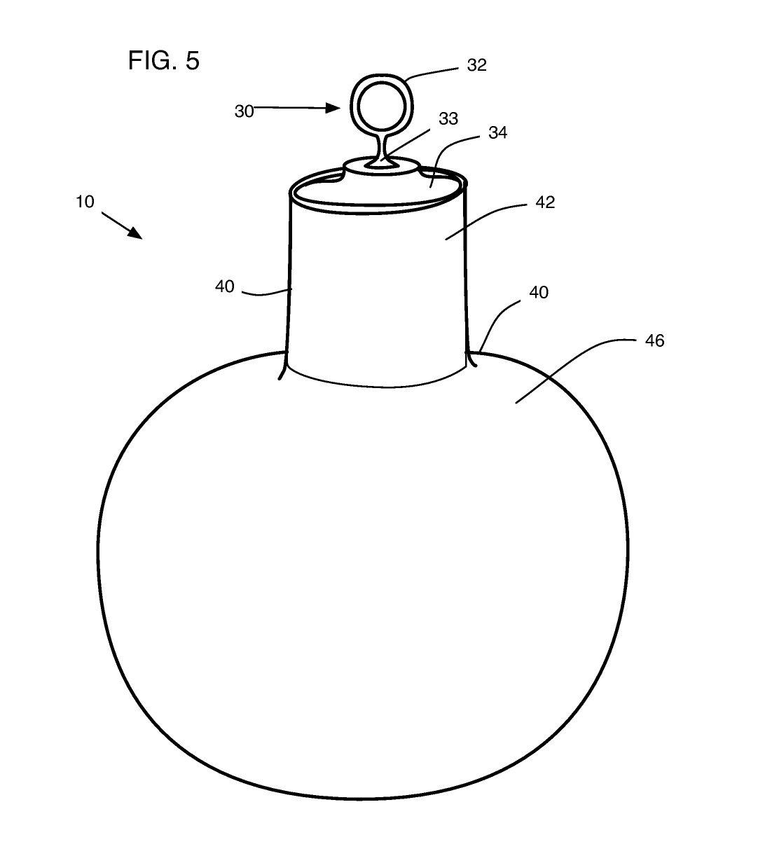

FIG. 5 illustrates another preferred embodiment of the present invention. An eyelet 30 couples to a body member 46. The body member is a weighted mass, such as a solid stainless steel spherical ball. However, other shapes and materials would work equally well and are contemplated. The eyelet includes a ring 32 that defines a centered-through hole through which a fishing line would run. The ring is supported by a neck 33, which—in turn—is supported by a base 34. The neck sits in the base so to be swivel mounted, as would be well-understood in this art. The base is glued to the body member. The base and body member are covered in a sheath 40, which is then heat-shrinked to be form fitting over the body member and base of the eyelet.

Thus, FIG. 5 shows an improved fishing weight 10 comprising: a body member 46; an eyelet member 30 comprising a base 34, the base supporting a neck 33, and the neck supporting a ring 32, the ring defining an opening, the eyelet member coupled to the body member; an outer sheath 40 overwrapping at least a portion 42 of the body member and at least a portion of the base.

Advantages to the present invention include a simple manufacturing process that does not require complicated or difficult machining of the ball 20. Also, polyolefin shrink-wrap film is a very cost effective choice for an outer layer of the present invention. It is strong, shape conforming, and resists tearing. Polyolefin shrink film is clear, can be colored, very elastic, and has a smooth texture, which enables it to avoid tangling when on a fishing line.

Benefits of the present invention include a product that can be competitively manufactured in the USA and marketed as a premium product that will far outlast old-fashioned lead weights and any other weights on the market. The combination of a swivel mount on a ball and the assembly being shrink wrapped ensures a much more robust product that can survive the rigors of fast-moving, rock-strewn stream beds, sunken logs on lake bottoms, trawling, and repeated use. Contemplated material for the outer later include polyolefin, PVC, adhesive lined polyolefin, and flouropolymer, all of which are available at www.buyheatshrink.com.

Other contemplated materials include stainless steel, powder coated low-carbon steel, brass, stainless steel, chrome steel, carbon steel, brass, bronze, copper, bismuth, tungsten, aluminum, nickel, gold, silver, titanium, and basically any non-toxic element or metal available at a price that is economical at the current point of production, as would be appreciated by those skilled in the art.

Although the invention has been particularly shown and described with reference to certain embodiments, it will be understood by those skilled in the art that various changes in form and detail may be made without departing from the spirit and scope of the invention.

I claim:

1. An improved fishing weight comprising:
a body member;
an eyelet member comprising
a base, the base supporting a neck, and the neck supporting a ring, the ring defining an opening,
the eyelet member coupled to the body member;
an outer sheath overwrapping at least a portion of the body member and at least a portion of the base.

2. The improved fishing weight of claim 1 wherein:
the body member comprises a spherical ball.

3. The improved fishing weight of claim 1 wherein:
the base is coupled to the body member by means of an adhesive material disposed between the body member and the base.

4. The improved fishing weight of claim 1 wherein:
the eyelet member swivel mounts to the base whereby the eyelet member comprising the ring and neck, which cooperate to swivel mount to the base so that the ring may be disposed at in position about a 360-degrees of travel on an axis perpendicular to the body member.

5. The improved fishing weight of claim 1 wherein:
the body member comprises stainless steel.

6. The improved fishing weight of claim 1 wherein:
the outer sheath is disposed to overwrap the entire body member.

7. An improved fishing weight comprising:
a spherical ball comprising stainless steel;
a swivel mount comprising an eyelet member rotatably coupled to a base, the base coupled to the spherical ball; and
an outer sheath shrink fit to contain the ball and swivel mount.

8. A method of producing an improved fishing weight, the method comprising:
providing a body member comprising a weighted material;
providing an eyelet member;
providing an outer sheath comprising polyolefin film;
coupling the eyelet member to the body member;
wrapping the outer sheath around a portion of the body member and a portion of the eyelet member; and
heat-shrinking the outer sheath.

9. The method of claim 8 further comprising:
providing a base;
providing an adhesive;
adhereing the adhesive to the base and the base to the body member;
mounting the eyelet to the base whereby the eyelet rotates 360-degrees about an axis relative to the base.
